(19) United States
(12) Patent Application Publication
(10) Pub. No.: US 2005/0163124 A1
(43) Pub. Date: Jul. 28, 2005

(54) Method and system for converting data

(75) Inventor: Herbert Heiss, Puchheim (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/501,478

(22) PCT Filed: Jan. 10, 2003
(86) PCT No.: PCT/DE03/00066

(30) Foreign Application Priority Data
Jan. 15, 2002 (DE) 102 01 310.1

(51) Int. Cl. H04L 12/28

(52) U.S. Cl. 370/395.1

(57) ABSTRACT

The invention relates to a data conversion method whereby a packet-based data transfer is converted into a data transfer which is synchrronised in time slots, and packets are stored in a conversion buffer memory (3). According to the invention, a packet is rejected at the end of a time interval (Tx) if, during the time interval Tx, the number of data packets never falls below a threshold value t>0 in the conversion buffer memory (3). The invention also relates to a data conversion system.

### CLAIM FOR PRIORITY

This application is a national stage of International Application No. PCT/DE03/00066 which was published on Jul. 24, 2003 and which claims the benefit of priority to German Application No. 102 01 310.1 filed Jan. 15, 2002.

### TECHNICAL FIELD OF THE INVENTION

The present invention relates to a data conversion method and a data conversion system.

### BACKGROUND OF THE INVENTION

ATM (Asynchronous Transfer Mode) networks are being used to an ever greater extent for digital data transfer. ATM networks involve high-speed cell relay services where a large number of data types are transferred over a common communication medium. For the purposes of transfer, a continuous bit stream is usually converted into ATM cells, sent over the ATM network and then converted back into a continuous bit stream. In this respect, each ATM cell contains the same quantity of bytes. Consequently, ATM cells are generated with a constant time interval between consecutive cells.

However, ATM networks generate a certain time lag between the cells that are sent. Consequently, the time interval between consecutive cells varies following transfer within an ATM network.

In the event that the conversion of ATM cells into a continuous bit stream begins after the receipt of the first cell, the second cell can feature a greater delay than the first cell. Accordingly, the second cell is not available when it is needed in this case. This procedure leads to a stoppage in transmission with the result that bytes without any data content have to be inserted. Consequently, the conversion of ATM cells back into a continuous bit stream is not usually started prior to the time point at which the first cell is received, but only after a delay which corresponds to the maximum time lag.

Consequently a buffer memory is needed during the conversion in order to be able to store the ATM cells temporarily until they are needed. In this respect, the size of the buffer memory must be selected so as to be sufficiently large. If too small a buffer memory is selected, a situation could arise where a received ATM cell has to be discarded.

The same procedure essentially also arises in the case of AAL2 (ATM Adaptation Layer Type 2) networks. AAL2 is an ATM layer which is specified in ITU-T Recommendation 1.363.2. AAL2 provides efficient voice services for ATM networks. AAL2 supports features such as efficient use of bandwidth, support for voice compression, recognition or suppression of noiselessness, deletion of empty voice channels and provision of a number of voice channels with varying bandwidth for a single ATM connection.

In the case of the transfer of compressed voice, each AAL2 packet contains 160 bytes of uncompressed voice sampling data. The AAL2 packets for each connection are generated every 20 ms. They are then transferred within an ATM or AAL2 network. Due to the variance in the AAL2 packet delay within the network, the time interval between consecutive packets varies during the data conversion, i.e. during the conversion of the AAL2 packets into a time division multiplexed data stream. In this respect, 160 bytes every 20 ms corresponds to 64 kbits per second. Consequently, the conversion cannot start at the time the first AAL2 packet arrives but only after a certain time lag. If the AAL2 packet delay can be limited to 10 ms, then the conversion delay comprises 10 ms for example.

However, problems arise if AAL2 packets are received with a delay of more than 10 ms. In such a case, 160 bytes without any data content are usually added by the conversion device. This results in all time division multiplexed bytes displaying an additional delay of 20 ms from that time point on.

One possibility for solving this problem consists in limiting the storage capacity of the conversion memory to a maximum of one packet. If only one packet displays a delay greater than 10 ms, that packet arrives too late and is replaced by bytes without any data content. The next packet is deleted and then normal data transfer is effected again.

However, if the packets display a delay variance between 9 and 11 ms, every second packet is discarded and a packet without any data content is inserted in each case.

The small buffer memory was an advantage in the first case but a disadvantage in the second.

The same problem also arises with ATM and IP (Internet Protocol) networks.

Furthermore, D1 discloses a device which includes a reception interface with a queue for incoming data packets. D2 discloses the reception or reproduction of voice where the voice is transmitted by means of data packets over a communication system operating as defined by the Internet Protocol. D3 discloses a method, a system and also a computer program product for what is referred to as jitter management within a packet-switching network. None of the said publications provides a satisfactory solution to the aforesaid problem.

### SUMMARY OF THE INVENTION

The invention provides a data conversion method or a system for converting data where the time lag is reduced.

The data conversion method encompasses conversion of data transfer based on packets into data transfer which is synchronized in timeslots and storage of data packets in a conversion buffer memory.

Data transfer based on packets can involve an asynchronous data transfer method, in particular ATM, for example. However, the present invention is essentially applicable to any type of data transfer based on packets. The data transfer which is synchronized in timeslots preferably involves data transfer which is synchronized in time division multiplexing.

The data packets are stored temporarily in a conversion buffer memory. The conversion buffer memory can essentially involve any type of storage device.

For the purposes of reducing the transmission delay during conversion of data transfer based on packets into data transfer which is synchronized in timeslots, a packet is discarded at the end of a time interval Tx if the number of packets in the conversion buffer memory never falls below a threshold value t>0 during that time interval. In this respect, the reduction in the transmission delay comprises at least a time interval Tq if a data packet is discarded during conversion. Tq is the interval between two consecutive packets at the source. In this respect, the reduction in the transmission delay is more important for the overall system than a limited loss of packets. A conversion operation takes place following the expiry of the time interval Tx. A new time interval Tx then begins and the method is repeated.

In the case of AAL2 networks, the time interval Tx comprises 20 seconds for example. Such a time interval of 20 seconds therefore corresponds to 1,000 time intervals Tq=20 ms. Other values for Tx and Tq arise correspondingly for other networks.

In another embodiment of the present invention, if the number of data packets in the conversion buffer memory is a threshold value t=1, a data packet is discarded if at least one data packet is always present in the conversion buffer memory during a time interval of duration Tx.

In a preferred embodiment of the present invention, the threshold value t is made greater than or equal to two if two consecutive data packets arrive which belong together and/or one data packet is useless without the other. Data services exist where data packets always occur in pairs and one is useless on its own. This can apply to AAL2 packets in the case of broadband AMR (Adaptive Multi-Rate), for example, if the packets are sent in pairs.

In this respect, two data packets are discarded if the number of data packets in the conversion buffer memory never falls below a threshold value t which is greater than or equal to two during the time interval Tx. However, the data transfer can also be effected according to the ATM or IP standard in this respect.

In a further preferred embodiment, the data transfer based on packets is effected according to the AAL2 (Asynchronous Transfer Mode Adaptation Layer Type 2) standard. In this respect, the data to be converted is preferably voice data. However, any type of data can essentially also be involved in this respect.

In still another embodiment, the packets involve packets of a sub-layer. In particular, CPS (Common Part Sub-Layer) packets are involved. AAL2 packets can be subdivided into two sub-layers. These sub-layers are referred to as the Conversion Sub-Layer (CS) and the Segmentation and Re-Assembly (SAR). The CS can be subdivided again into two sub-layers, specifically referred to as the Common Part Sub-Layer (CPS) and the Service Specific Conversion Sub-Layer (SSCS). The utilization of the CPS ensures efficient use of the bandwidth resources.

The invention also relates to a data conversion system. The data conversion system for converting data transfer based on packets into data transfer which is synchronized in timeslots exhibits a means of conversion and a conversion buffer memory for storing data packets. In the means of conversion, the packet data is converted into data which is synchronized in timeslots.

In a preferred embodiment, the system furthermore encompasses a control device for controlling the discarding of a data packet. The control device can involve a micro-controller for example.

The individual components of the data conversion system can be arranged in one device or separately in this respect.

The invention is not restricted to ATM, AAL2 or IP data conversion. The present invention is essentially applicable to any type of data conversion where synchronous data traffic is converted into asynchronous data traffic and then back into synchronous data traffic.

### BRIEF DESCRIPTION OF THE DRAWINGS

In the following, the invention is explained in detail on the basis of an exemplary embodiment by reference to the enclosed drawing. The features shown therein and also the features already described above can be essential to the invention not only in the said combination but also individually or in other combinations. All features described in the overall description and in the claims with regard to the method can also be essential to the invention with regard to the system and vice versa. The diagrams show:

FIG. 1 shows a diagram of a system for converting data transfer based on packets into data transfer which is synchronized in timeslots.

### DETAILED DESCRIPTION OF THE INVENTION

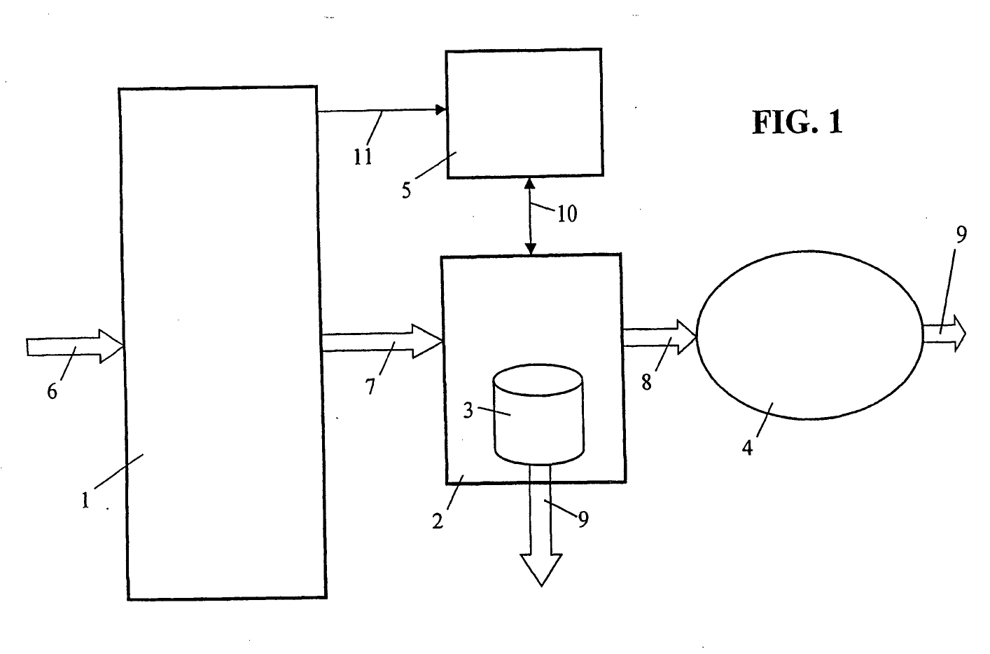

The exemplary embodiment shown in FIG. 1 involves a data conversion system for converting voice data in AAL2 format into TDM (Time Division Multiplex) data.

FIG. 1 shows an ATM network 1, a data conversion card 2 with a conversion buffer memory 3, a TDM network 4 and a control device 5. The arrangement of the elements data conversion card 2, conversion buffer memory 3 and control device 5 is not compulsory. It is entirely conceivable that the conversion buffer memory 3 is located outside the conversion card 2 for example, or that the control device 5 is located on the conversion card 2 for example.

An external data stream 6 is transferred over an ATM network 1. To this end, the data stream 6 must be converted into ATM AAL2 packets (not shown). Then the AAL2 packets are fed to the conversion card 2 as shown by the arrow 7.

If storage locations are available in the conversion buffer memory, the AAL2 packets to be converted are stored temporarily in the latter. A packet is discarded 9 at the end of a time interval Tx (e.g. Tx=20 s) if a minimum quantity of packets is constantly present in the conversion buffer memory during that time interval Tx.

The control device 5 controls the discarding of AAL2 packets. To this end, it receives information 11 from the ATM network 1. In addition, it communicates with or controls 10 the conversion card 2 or the conversion buffer memory 3. In this respect, the control device 5 continuously monitors the conversion buffer memory 3 or take account of the time interval Tx. The controlling or discarding of AAL2 packets reduces the transmission delay during conversion by at least one time interval. Following conversion, the data is fed to a TDM network 4 in the form of a TDM data stream. The data can subsequently be forwarded as desired 9.

The following steps are carried out for the conversion.

If an AAL2 voice data packet does not arrive for conversion at the correct time, no voice is output, i.e. muting is effected.

When an AAL2 packet arrives at the conversion card, it is stored in the conversion buffer memory if the latter is not full (if fewer than four packets are waiting, for example). If the conversion buffer memory is full, the packet is discarded.

If a CPS packet is removed from the queue for the connection and if the queue is then, following the removal, smaller than a threshold value t>0, a connection-specific variable Q is set to TRUE. The variable Q can have the states TRUE and FALSE. In the original state, Q is set to TRUE.

Every Tx seconds (or TX per 20 ms CPS packets), the following occurs for each connection: if the variable Q=FALSE, a CPS packet is discarded from each connection queue. The variable is then set to Q=FALSE in each case. The procedure described is then repeated accordingly.

1. A data conversion method, comprising:
converting data transfer based on data packets into data transfer which is synchronized in timeslots;
storing the data packets in a conversion buffer memory; and
discarding a data packet at the end of a time interval Tx if a number of the data packets in the conversion buffer memory does not fall below a threshold value t>0 during the time interval Tx.

2. The method in accordance with claim 1, wherein
a transmission delay reduced by at least a time interval Tq occurs during conversion if the data packet is discarded during conversion.

3. The method in accordance with claim 1, wherein
when a quantity of data packets t=1, the data packet is discarded if at least one data packet is present in the conversion buffer memory during the time interval Tx.

4. The method in accordance with claim 1, wherein
the threshold value t is made greater than or equal to two if two consecutive data packets arrive which belong together and/or one data packet is useless without the other.

5. The method in accordance with claim 4, wherein
the two data packets are discarded if the number of data packets in the conversion buffer memory does not falls below the threshold value t which is greater than or equal to two during the time interval Tx.

6. The method in accordance with claim 1, wherein
the data transfer based on data packets is effected according to a Asynchronous Transfer Mode Adaptation Layer Type 2 standard.

7. The method in accordance with claim 1, wherein
the transfer which is synchronized in the timeslots is effected according to a timeslot multiplexing method.

8. The method in accordance with claim 1, wherein
the data involves voice data.

9. The method in accordance with claim 1, wherein
the data packets involve Common Part Sub-Layer packets.

10. A data conversion system for converting data transfer based on data packets into data transfer which is synchronized in timeslots, comprising:
a conversion device; and
a conversion buffer memory for storing data packets for discarding a data packet at an end of a time interval Tx when a number of the data packets in the conversion buffer memory not falling below a threshold value t>0 during the time interval Tx.

11. The system in accordance with claim 10, wherein
the system displays a control device for controlling the discarding of a data packet.

12. The system in accordance with claim 10, wherein
a transmission delay reduced by at least a time interval Tq occurs during conversion when a data packet is discarded.

13. The system in accordance with claim 10, wherein the discarding of the data packet when a quantity of the data packets t=1, if at least one data packet is present in the conversion buffer memory during the time interval Tx.

14. The system in accordance with claim 10, wherein
the threshold value t is greater than or equal to two if two consecutive data packets arrive which belong together and/or one data packet is useless without the other.

15. The system in accordance with claim 14, wherein the discarding of two data packets if a number of data packets in the conversion buffer memory does not fall below the threshold value t which is greater than or equal to two during the time interval Tx.

16. The system in accordance with claim 10, wherein
the data transfer based on packets is effected according to an Asynchronous Transfer Mode Adaptation Layer Type 2 standard.

17. The system in accordance with claim 10, wherein
the transfer which is synchronized in timeslots is effected according to a timeslot multiplexing method.

18. The system in accordance with claim 10, wherein
the data involves voice data.

19. The system in accordance with claim 10, wherein
the data packets involve Common Part Sub-Layer packets.
